(19) United States
(12) Patent Application Publication
(10) Pub. No.: US 2026/0221534 A1
(43) Pub. Date: Jul. 30, 2026

(54) COOLING PANEL FOR IMPROVED COOLING EFFICIENCY FOR PRISMATIC BATTERY CELLS

(71) Applicant: GM Global Technology Operations LLC, Detroit, MI (US)

(72) Inventors: Diptak Bhattacharya, Royal Oak, MI (US); William Yu Chen, Troy, MI (US); Lu Huang, Troy, MI (US); Matthew Arthur Celentano, Berkley, MI (US); Andrew Clay Bobel, Troy, MI (US); Derek Frei Lahr, Ann Arbor, MI (US); Jorge F. Arinez, Rochester Hills, MI (US)

(21) Appl. No.: 19/040,369

(22) Filed: Jan. 29, 2025

(51) Int. Cl. H01M 10/6556; H01M 10/613; H01M 10/647; H01M 10/6554; H01M 10/6568; H01M 50/249; B60L 50/64

(52) U.S. Cl. CPC H01M 10/6556; H01M 10/613; H01M 10/647; H01M 10/6554; H01M 10/6568; H01M 50/249; B60L 50/64; H01M 2220/20

(57) ABSTRACT

A cooling panel for regulating the temperature of a prismatic battery cell. The cooling panel comprises at least a first laminate and a second laminate, which are heat-sealed together to create a pouch, which is then disposed between a first blanked sheet and a second blanked sheet, which are pressed and affixed together, creating a frame. The pouch has an inlet and an outlet disposed within itself, allowing for a coolant to be directed through the pouch. The coolant is directed to the pouch via the inlet, causing the pouch to expand, allowing for the pouch to communicate with at least one side surface of a prismatic battery cell, allowing the cooling panel to regulate the temperature of the prismatic battery cell and preventing overheating and thermal runaway events. The coolant then exits the pouch via the outlet where the coolant can be reused for further temperature regulation.

### INTRODUCTION

The present disclosure relates to a cooling panel for a prismatic battery cell.

Electric vehicles and hybrid vehicles employ a high voltage electric battery system that includes a number of battery cells. These electric and hybrid vehicles typically require several battery cells to provide enough power to meet vehicle power and energy requirements. The battery cells are often located under the vehicle body midway between the front and rear wheels.

Battery cells, particularly of the high-voltage type described above, generate substantial amounts of heat during sustained operation and fast charging. Over time, the generated heat may degrade the efficiency or lead to thermal runaway events. Thermal management systems are therefore used to closely regulate the temperature of the battery pack. In one type of thermal management system where prismatic battery cells are used, cooling plates are often disposed below the prismatic battery cells to regulate their temperature and prevent overheating and thermal runaway events from occurring.

Thus, while current cooling plates achieve their intended purpose, there is a need for a new and improved system and method for cooling prismatic battery cells to prevent overheating or thermal runaway events.

### SUMMARY

According to several aspects, A cooling panel for a prismatic battery cell is provided. The cooling panel may include: a frame including a first blanked sheet and a second blanked sheet, wherein the first blanked sheet is connected to the second blanked sheet. The cooling panel may also include a first outer laminate connected to the first blanked sheet. The cooling panel may also include a second outer laminate connected to the second blanked sheet wherein the first outer laminate and the second outer laminate are heat-sealed together to create a pouch disposed between the first blanked sheet and the second blanked sheet. The cooling panel may also include an inlet in communication with the pouch. The cooling panel may also include an outlet in communication with the pouch wherein a coolant communicates from the inlet to the pouch to inflate the pouch such that the first laminate contacts the prismatic battery cell, and the coolant communicates out of the pouch via the outlet.

In an additional aspect of the present disclosure, the pouch matches the shape of the first blanked sheet and the second blanked sheet and the first blanked sheet and the second blanked sheet together forms the frame to secure the pouch in place.

In another aspect of the present disclosure, the frame is composed of either a thinned aluminum or a plastic.

In an additional aspect of the present disclosure, the coolant is directed into the pouch through the inlet and out of the pouch through the outlet.

In another aspect of the present disclosure, the cooling panel is disposed within a battery pack housing the prismatic battery cell within a vehicle.

In an additional aspect of the present disclosure, the first outer laminate and the second outer laminate are composed of a flexible laminated stainless steel foil.

In another aspect of the present disclosure, an outer layer of the first outer laminate and the second outer laminate is composed of a thermoplastic polymer with a melting point between 250 and 350 degrees Celsius.

In an additional aspect of the present disclosure, an inner layer of the first outer laminate and the second outer laminate is composed of a thermoplastic polymer with a melting point between 160 and 200 degrees Celsius.

In another aspect of the present disclosure, the pressure from the coolant directed into the pouch through the inlet causes the pouch to expand and communicate with a side surface of the prismatic battery cell.

In an additional aspect of the present disclosure, the cooling panel further comprises a first inner laminate and a second inner laminate.

In another aspect of the present disclosure, the first inner laminate and the second inner laminate are composed of a flexible aluminum foil.

In an additional aspect of the present disclosure, a first inner pouch within the pouch would be defined by the space between the first outer laminate and the first inner laminate, a central pouch within the pouch would be defined by the space between the first inner laminate and the second inner laminate, and a second inner pouch within the pouch would be defined by the space between the second inner laminate and the second outer laminate.

In another aspect of the present disclosure, an outer layer of the first outer laminate and the second outer laminate is composed of a thermoplastic polymer with a melting point between 250 and 350 degrees Celsius and an inner layer of the first outer laminate and the second outer laminate is composed of a thermoplastic polymer with a melting point between 160 and 200 degrees Celsius.

In an additional aspect of the present disclosure, a first layer and a third layer of the first inner laminate and the second inner laminate are composed of a thermoplastic polymer with a melting point between 160 and 200 degrees Celsius.

In another aspect of the present disclosure, the pressure from the coolant directed into the first inner pouch and the second inner pouch through the inlet causes the pouch to expand and communicate with a side surface of the prismatic battery cell.

In an additional aspect of the present disclosure, the central pouch is filled with a thermal barrier.

In another aspect of the present disclosure, a single serpentine channel is heat-sealed within the pouch, allowing for the inlet and the outlet to be disposed within a same edge of the pouch.

In an additional aspect of the present disclosure, there are a plurality of round seals heat sealed into the pouch to induce turbulence in the flow of the coolant.

According to several aspects, a cooling panel for a prismatic battery cell is provided. The cooling panel may include a frame including a first blanked sheet and a second blanked sheet, wherein the first blanked sheet is connected to the second blanked sheet. The cooling panel may also include a first outer laminate connected to the first blanked sheet. The cooling panel may also include a second outer laminate connected to the second blanked sheet. The cooling panel may also include a first inner laminate adjacent to the first outer laminate. The cooling panel may also include a second inner laminate adjacent to the second outer laminate wherein the first outer laminate, the first inner laminate, the second inner laminate, and the second outer laminate are heat-sealed together to create a pouch disposed between the first blanked sheet and the second blanked sheet. The cooling panel may also include an inlet in communication with the pouch. The cooling panel may also include an outlet in communication with the pouch wherein a coolant communicates from the inlet to the pouch to expand the pouch such that the first laminate contacts the prismatic battery cell, and the coolant communicates out of the pouch via the outlet.

According to several aspects, a cooling panel for a prismatic battery cell is provided. The cooling panel may include a frame including a first blanked sheet and a second blanked sheet, wherein the first blanked sheet is connected to the second blanked sheet. The cooling panel may also include a first laminate connected to the first blanked sheet. The cooling panel may also include a second laminate connected to the second blanked sheet wherein the first laminate and the second laminate are heat-sealed together to create a pouch disposed between the first blanked sheet and the second blanked sheet. The cooling panel may also include an inlet in communication with the pouch. The cooling panel may also include an outlet in communication with the pouch. wherein a coolant communicates from the inlet to the pouch to expand the pouch such that the first laminate contacts the prismatic battery cell, and the coolant communicates out of the pouch via the outlet. The cooling panel may also include a plurality of round seals heat sealed into the pouch to induce turbulence in the flow of the coolant.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a perspective view of an exemplary vehicle including an exemplary battery pack having a cooling panel according to an exemplary embodiment;

FIG. 2 is a schematic top view of an example thermal management system for the battery pack according to an exemplary embodiment;

FIG. 3 is a perspective view of the cooling panel according to an exemplary embodiment;

FIG. 4 is a cross-section view of the laminate structure according to an exemplary embodiment;

FIG. 5 is a perspective view of an alternate embodiment of the laminate structure according to an exemplary embodiment;

FIG. 6A is a perspective view of the cooling panel having a single straight channel according to an exemplary embodiment;

FIG. 6B is a perspective view of the cooling panel having a plurality of straight channels according to an exemplary embodiment;

FIG. 6C is a perspective view of the cooling panel having a serpentine channel according to an exemplary embodiment;

FIG. 6D is a perspective view of the cooling panel having a plurality of round seals according to an exemplary embodiment;

FIG. 7 is a side view of a frame in the battery pack used to support the cooling panel according to an exemplary embodiment;

FIG. 8A is a side view of the cooling panel while a coolant is directed through the cooling panel where the laminate structure is composed of four laminates according to an exemplary embodiment;

FIG. 8B is a side view of the cooling panel while a coolant is directed through the cooling panel where the laminate structure is composed of two laminates according to an exemplary embodiment.

### DETAILED DESCRIPTION

The following description is merely exemplary in nature and is not intended to limit the present disclosure, application, or uses.

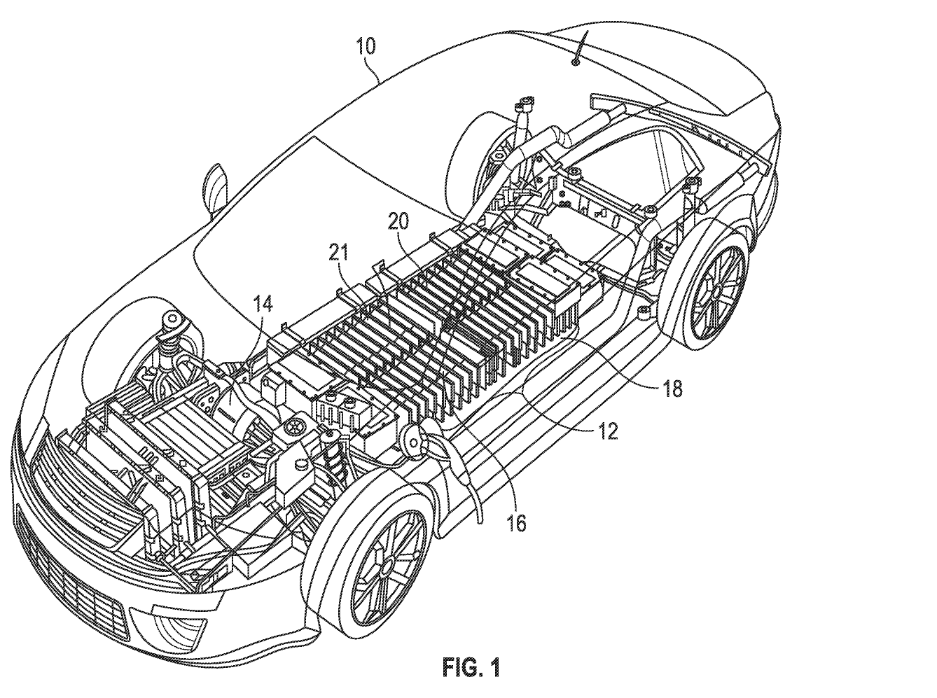

Referring to FIG. 1, an exemplary vehicle 10 having a battery pack 12 for providing power to an electric motor 14 is shown. While the vehicle 10 is illustrated as a passenger car, it should be appreciated that the vehicle may be any type of vehicle, including a truck, a boat, a drone, an airplane, etc., without departing from the scope of the present disclosure. The electric motor 14 provides motive power to the vehicle 10. However, the battery pack 12 may be used in a variety of other electromobility and stationary applications and may be used to power other electrical hardware without departing from the scope of the present disclosure. The battery pack 12 includes a plurality of prismatic battery cells 16 that are electrically connected to one another. The battery pack 12 is supported by a battery tray 18. The prismatic battery cells 16 generally include a housing 20 that encloses an electrode stack (not shown) and an electrolyte (not shown) for generating energy. During use and charging, the prismatic battery cells 16 generate heat. The battery pack 12 includes a thermal management system 21 to manage the heat generated by the prismatic battery cells 16.

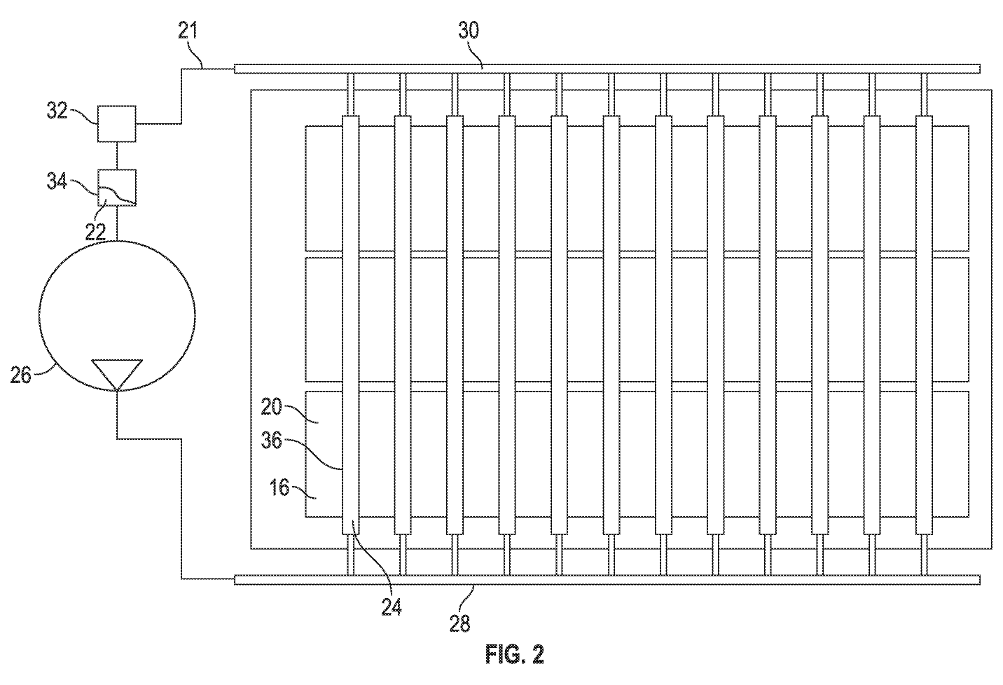

Referring to FIG. 2, a schematic top view of the thermal management system 21 for the battery back 12 is shown. The thermal management system 21 directs a coolant 22 therethrough to regulate the temperature of the prismatic battery cells 16 within the battery pack 12. In a list of non-limiting examples, the coolant 22 may be water, glycol-water mixtures, mineral oils, dielectric fluids, inorganic acid technology coolants, and organic acid technology coolants. The thermal management system 21 generally includes at least one cooling panel 24 according to the principles of the present disclosure, as well as a pump 26, an inlet line 28, an outlet line 30, a heat exchanger 32, and a recovery tank 34. The thermal management system 21 may include various other components including temperature and humidity sensors, valves, and electronic controllers, without departing from the scope of the present disclosure. Generally, the pump 26 is in fluid communication with the recovery tank 34 and pumps the coolant from the recovery tank 34 to the inlet line 24. The inlet line 28 is connected to one or more of the cooling panels 20, and directs the coolant 22 from the pump 26 to the cooling panels 20. The cooling panels 20 are disposed between individual prismatic battery cells 16, as will be described in greater detail below. The cooling panels 20 contact a side surface 36 of the housing 20 of an adjacent prismatic battery cell 16 and provide thermal management. The side surface 36 of the individual prismatic battery cell 16 is a surface of the individual prismatic battery cell 16 that runs along the length of the prismatic battery cell. The coolant is subsequently returned from the cooling panels 20 to the outlet line 30 and communicated to the heat exchanger 32. The heat exchanger 32 removes heat from the coolant, for example, using a liquid to air heat exchanger with a fan, though other types of heat exchangers may be employed. The coolant is returned to the recovery tank 34.

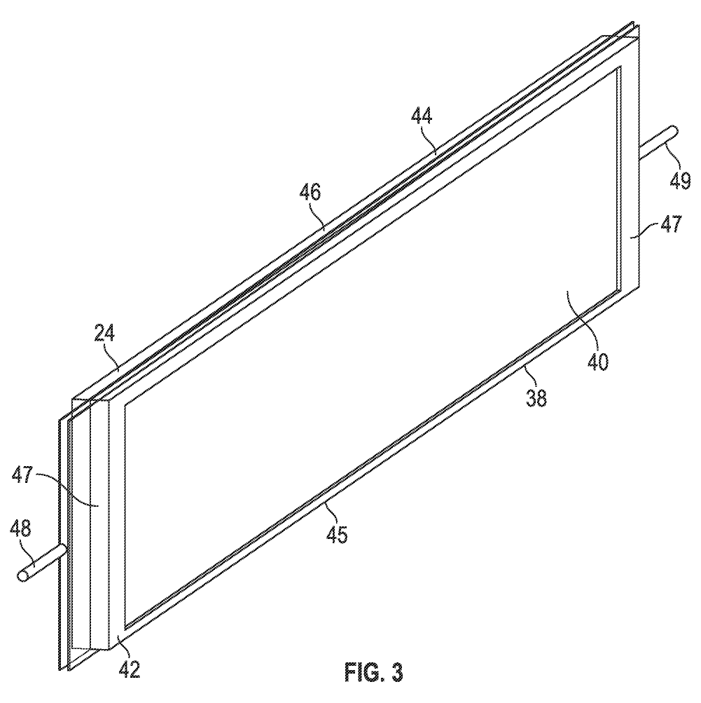

Referring to FIG. 3, a perspective view of the cooling panel 24 is shown. The cooling panel 24 regulates the temperature of at least one prismatic battery cell 16 from the battery pack 12. The cooling panel 24 is disposed directly beside and is positioned parallel to the side surface 36 of the adjacent prismatic battery cell 16. The cooling panel 24 includes a frame 38 that supports a laminate structure 40. The laminate structure 40 is disposed between the frame 38. The frame 38 is sized to approximately match one or more prismatic battery cells 16 arranged end to end, as shown in FIG. 2. The frame 38 includes a first blanked sheet 42 coupled to a second blanked sheet 44 that, when coupled together, define a bottom frame member 45, a top frame member 46, and end frame members 47. An inlet 48 and an outlet 49 communicate with the laminate structure 40.

The frame 38 includes a first blanked sheet 42 and a second blanked sheet 44 that are blanked into the same shape and are disposed parallel to one another. In a non-limiting example, the first blanked sheet 42 and the second blanked sheet 44 are rectangular. The first blanked sheet 42 and the second blanked sheet 44 can be composed of either plastic or aluminum. The periphery of either the first blanked sheet 42 or the second blanked sheet 44 is then aligned with a thermoplastic polymer adhesive, the laminate structure 40 is disposed between and situated parallel to the first blanked sheet 42 and the second blanked sheet 44, the two blanked sheets are pressed together, securing the two blanked sheets to each other via the thermoplastic polymer adhesive and securing the laminate structure 40 in place.

The inlet 48 and the outlet 49 are disposed within an edge of the laminate structure 40 wherein a portion of the inlet 48 and the outlet 49 protrude outwards from the laminate structure 40.

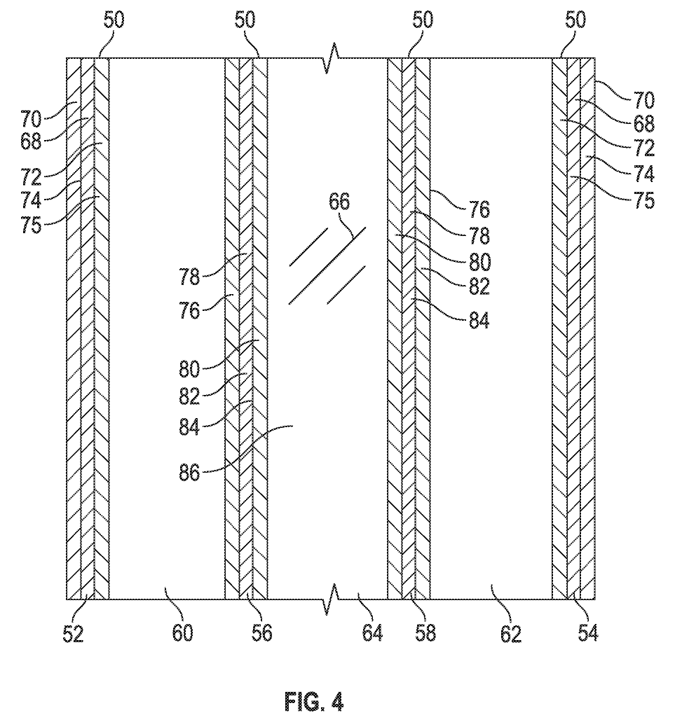

Referring to FIG. 4, a cross-section view of the laminate structure is shown. The laminate structure is configured to receive and communicate the coolant 22 therethrough in order to thermally regulate the prismatic battery cells 16, as will be described in greater detail below. The laminate structure includes a plurality of laminates 50 arranged parallel to one another within the frame. In one embodiment, the plurality of laminates 50 includes a first outer laminate 52, a second outer laminate 54, a first inner laminate 56, and a second inner laminate 58.

The first outer laminate 52 and the second outer laminate 54 are disposed on the outboard sides of the coolant panel 20. Accordingly, the first outer laminate 52 and the second outer laminate 54 are each configured to contact the side surface 36 of an adjacent prismatic battery cell 16. The first inner laminate 56 and the second inner laminate 58 are disposed between the first outer laminate 52 and the second outer laminate 54. The first outer laminate 52 and the first inner laminate 56 are sealed together along a periphery thereof at the frame 38 to define a first inner pouch 60 therebetween. The second outer laminate 54 and the second inner laminate 58 are also sealed together along a periphery thereof at the frame 38 to define a second inner pouch 62 therebetween. The inlet 48 communicates with the first inner pouch 60 and the second inner pouch 62 at one end thereof, while the outlet 49 communicates with the first inner pouch 60 and the second inner pouch 62 at another end thereof, as shown in FIG. 3. The first inner laminate 56 and the second inner laminate 58 are sealed along a periphery thereof at the frame 38 to define a central pouch 64 therebetween. The central pouch 64 may be used to house a thermal barrier 66, which would be used to minimize the flow of heat from a prismatic battery cell which is disposed adjacent to the cooling panel 24 to the rest of the battery pack 12. In a non-limiting example, the thermal barrier 66 may be air. In another non-limiting example, the thermal barrier 66 may be a foam, such as a foam board or a spray foam. In another non-limiting example, the thermal barrier 66 may be some other insulation material that is resistant to heat transfer, such as fiberglass, cellulose, or a silica-based aerogel.

The first outer laminate 52 and the second outer laminate 54 are substantially identical, and each include a central layer 68, an outer layer 70, and an inner layer 72. The outer layer 70 is laminated to a first side 74 of the central layer 68. The outer layer 70 is configured to directly contact the side surface 36 of the adjacent prismatic battery cell 16. The outer layer 70 is composed of a first thermoplastic polymer that has a melting temperature between 250 to 350 degrees Celsius. In a non-limiting example, the outer layer 70 is composed of polyethylene terephthalate. In another non-limiting example, the outer layer 70 is composed of polyamide. The inner layer 72 is laminated to a second side 75 of the central layer 68 opposite the first side 74. The inner layer 72 partially defines the first inner pouch 60 and the second inner pouch 62. The inner layer 72 is composed of a second thermoplastic polymer that has a melting temperature between 160 to 200 degrees Celsius. In a non-limiting example, the inner layer 72 is composed of polypropylene. The central layer 68 is configured to provide heat transfer between the first inner pouch 60 and second inner pouch 62 and the adjacent prismatic battery cells 16. In a non-limiting example, the central layer 68 is composed of a flexible stainless-steel foil.

The first inner laminate 56 and the second inner laminate 58 are substantially identical and each include a first layer 76, a second layer 78, and a third layer 80. The first layer 76 is laminated to a first face 82 of the second layer 78. The first layer 76 is configured to directly contact the side surface 36 of the adjacent prismatic battery cell 16. The first layer 76 is composed of the second thermoplastic polymer. The third layer 80 is laminated to a second face 84 of the second layer 78 opposite the first face 82. The third layer 80 partially defines the central pouch 64. The inner layer 72 is composed of the second thermoplastic polymer. In a non-limiting example, the second layer 78 is composed of a flexible aluminum foil.

The inlet 48 and the outlet 49 are disposed between the first outer laminate 52 and the second outer laminate 54 along an edge of the laminates wherein a portion of the inlet 48 and the outlet 49 protrude outwards from the first outer laminate 52 and the second outer laminate 54. The first outer laminate 52 and the second outer laminate 54 are then sealed together along a periphery thereof at the frame 38 to define a pouch 86 therebetween. The coolant 22 may be directed within the pouch 86 through the first inner pouch 60 and the second inner pouch 62. In this example, the pouch’s 48 laminate structure 40 comprises four laminates, wherein a portion of the inlet 48 and the outlet 49 protrude outwards from the pouch 86.

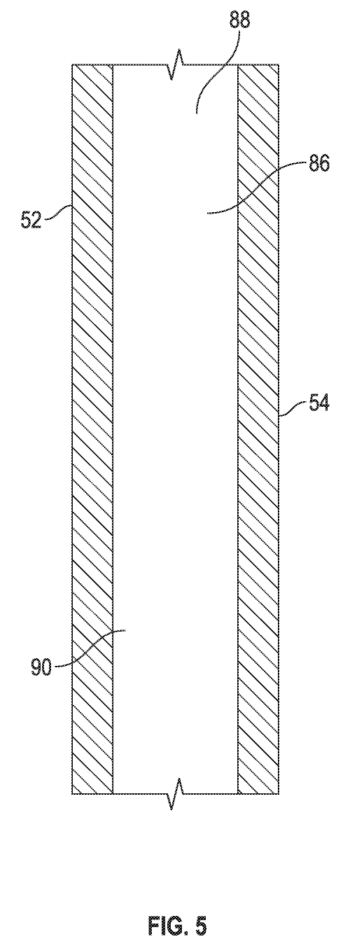

Referring to FIG. 5, a perspective view of an alternate embodiment of the laminate structure 40 is shown and generally indicated by reference number 88. The laminate structure 88 is similar to the laminate structure 40 shown in FIG. 4 and therefore like components are indicated by like reference numbers. However, the first inner laminate 56 and the second inner laminate 58 are removed, and the first outer laminate 52 and the second outer laminate 54 define a central coolant pouch 90. The laminate structure 88 provides a simpler construction while still allowing for the coolant 22 to be directed within the pouch 86 through the central coolant pouch 90, with the coolant 22 entering the pouch 86 through the inlet 48 and exiting the pouch 86 through the outlet 49.

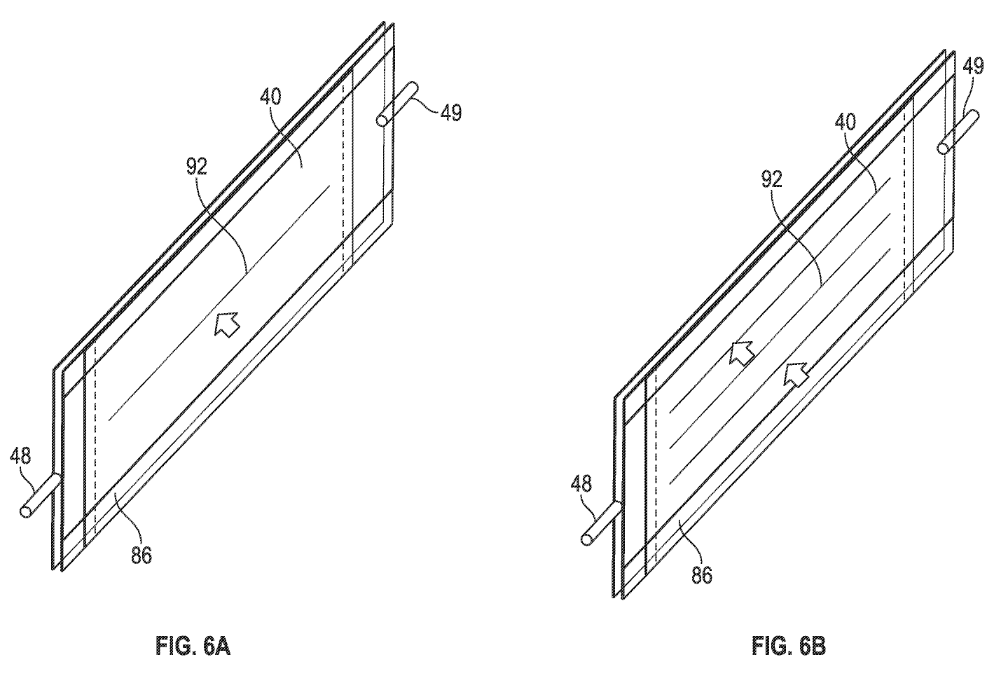

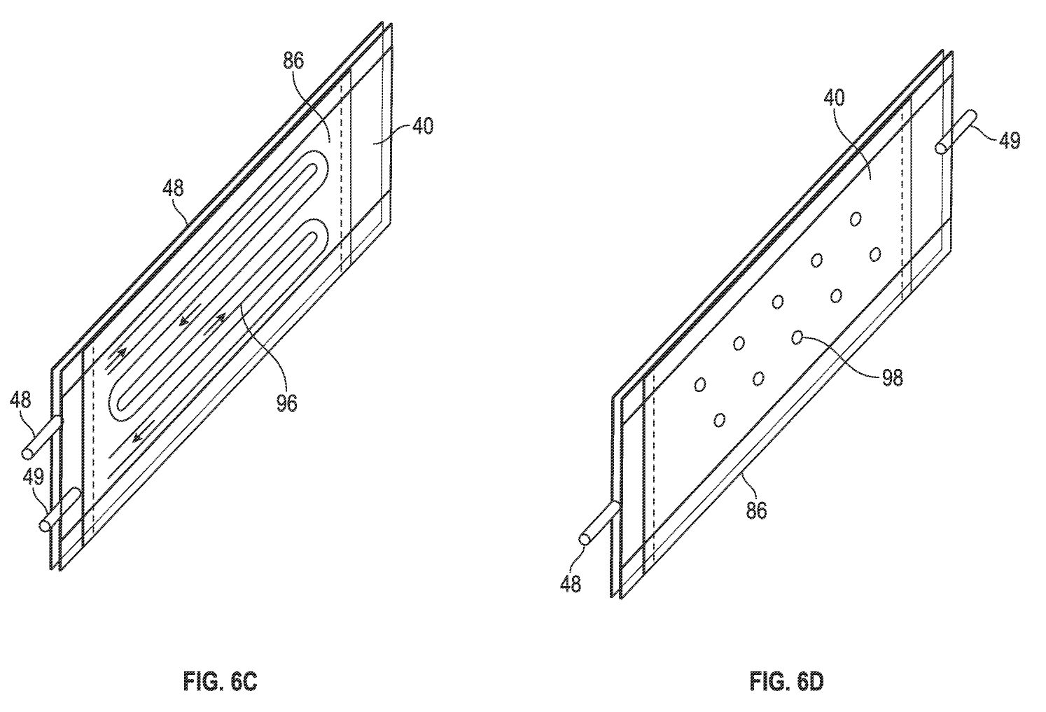

Referring generally to FIGS. 6A-6D, the laminate structure 40 may be heat sealed within the frame 38 in different configurations to provide different coolant flow options. Referring to FIG. 6A, a configuration of the pouch 86 heat sealed to form a single straight channel 92 within the pouch 86 is shown. This configuration allows for the coolant 22 to be directed through the pouch 86 from the inlet 48, which is disposed within an edge of the pouch 86, to the outlet 49, which is disposed within an opposite edge of the pouch 86 to which the inlet 48 is disposed. In this configuration, the coolant 22 is directed through the pouch 86 through two streams, which are defined as the two distinct spaces within the pouch 86 separated by the single straight channel 92. The two streams assist in maintaining a uniform temperature across an individual prismatic battery cell from the plurality of prismatic battery cells 16. The inlet line 24 and the outlet line 26 are disposed along opposite edges of the frame 38.

Referring to FIG. 6B, a configuration of the pouch 86 heat sealed to form a plurality of straight channels 94 within the pouch 86 is shown. This configuration allows for the coolant to be directed through the pouch 86 from the inlet 48, which is disposed within an edge of the pouch 86, to the outlet 49, which is disposed within an opposite edge of the pouch 86 to which the inlet 48 is disposed. In this configuration, the coolant 22 is directed through the pouch 86 by a plurality of streams, which are defined as the spaces within the pouch 86 separated by the plurality of straight channels 94. The plurality of streams assist in maintaining a uniform temperature across an individual prismatic battery cell from the plurality of prismatic battery cells 16. The inlet line 24 and the outlet line 26 are disposed along opposite edges of the frame 38.

Referring to FIG. 6C, a configuration of the pouch 86 heat sealed to form a single serpentine channel 96 within the pouch 86 is shown. This configuration allows for the coolant to be directed through the single serpentine channel 96 from the inlet 48, which is disposed within an edge of the pouch 86, to the outlet 49, which is disposed within the same edge of the pouch 86 to which the inlet 48 is disposed.

Referring to FIG. 6D, a configuration of the pouch 86 heat sealed to form a plurality of round seals 98 within the pouch 86 is shown. The plurality of round seals 98 allows for turbulence to be induced within the flow of the coolant 22 as the coolant 22 is being directed through the pouch 86, entering from the inlet 48, which is disposed within an edge of the pouch 86, and exiting from the outlet 49, which is disposed within an opposite edge of the pouch 86 to which the inlet 48 is disposed. The inlet line 24 and the outlet line 26 are disposed along opposite edges of the frame 38.

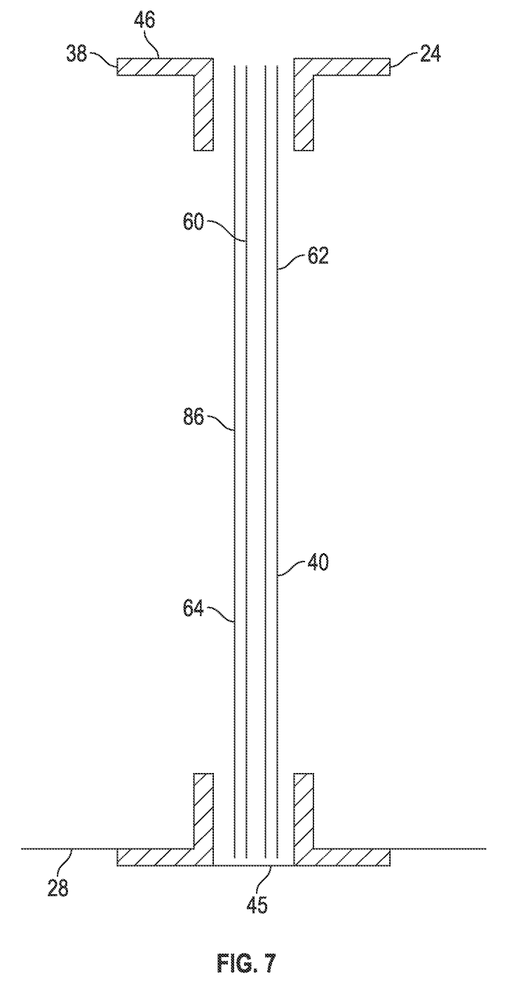

Referring to FIG. 7, the cooling panels 20 are held in place between adjacent prismatic battery cells 16 by the battery tray 18. For example, the battery tray includes a slot sized to receive the bottom frame member 45. The bottom frame member 45 is disposed within the groove. In one embodiment, as illustrated in FIG. 7, the bottom frame member has an I-shape and the slot has a matching I-shape. Therefore, the battery tray 28 secures the cooling panel 24 in a way that the cooling panel 24 is securely orientated perpendicular to the battery tray 28.

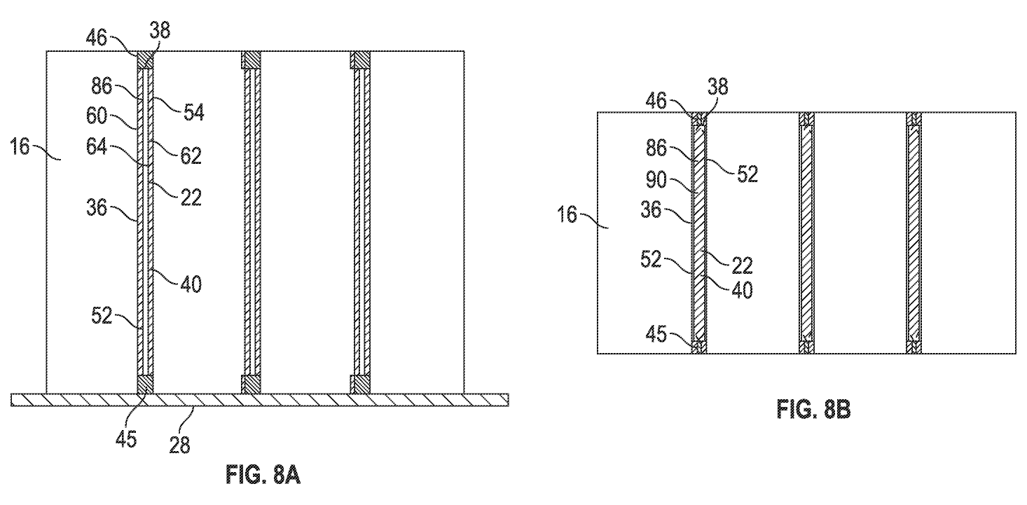

Referring to FIG. 8A, a side view of the cooling panel 24 while the coolant 22 is directed through the cooling panel 24 where the laminate structure is composed of four laminates is shown. When the coolant 22 is directed through the inlet 48 into the first inner pouch 60 and the second inner pouch 62, the coolant 22 expands the first inner pouch 60 and the second inner pouch 62, pushing the first outer laminate 52 and the second outer laminate 54 outward. Each of the first outer laminate 52 and the second outer laminate 54 directly contact the side surface 36 of the adjacent prismatic battery cell 16. The contact between the laminate structure 40 and the side faces of the adjacent prismatic battery cells 16 increases the conduction therebetween.

Referring to FIG. 8B, a side view of the cooling panel 24 while the coolant 22 is directed through the cooling panel 24 where the laminate structure 40 is comprised of two laminates is shown. When the coolant 22 is directed through the inlet 48 into the central coolant pouch 90, the coolant 22 expands the central coolant pouch 90, pushing the first outer laminate 52 and the second outer laminate 54 outward. Each of the first outer laminate 52 and the second outer laminate 54 directly contact the side surface 36 of the adjacent prismatic battery cell 16. The contact between the laminate structure 40 and the side faces of the adjacent prismatic battery cells 16 increases the conduction therebetween.

The cooling panel 24 of the present disclosure offers several advantages. One such advantage is the ability to cool a larger surface area of an individual prismatic battery cell from the plurality of prismatic battery cells 16 at any given time, allowing for a more efficient cooling process for the prismatic battery cell. This advantage also allows for the use of prismatic battery cells with faster charging rates (i.e. a prismatic battery cell that can be charged at a 3C rate as opposed to a 2C rate or a 1C rate) without a significantly heightened risk of a thermal runaway event. Another advantage of the cooling panel 24, and the thermal management system 21 in its entirety, is that the thermal management system 21 removes the need for a thermal interface material (i.e. a thermal paste, a thermal adhesive, etc.) in its assembly and execution.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A cooling panel for a prismatic battery cell, the cooling panel comprising:
a frame including a first blanked sheet and a second blanked sheet, wherein the first blanked sheet is connected to the second blanked sheet;
a first outer laminate connected to the first blanked sheet;
a second outer laminate connected to the second blanked sheet;
wherein the first outer laminate and the second outer laminate are heat-sealed together to create a pouch disposed between the first blanked sheet and the second blanked sheet;
an inlet in communication with the pouch; and
an outlet in communication with the pouch wherein a coolant communicates from the inlet to the pouch to inflate the pouch such that the first laminate contacts the prismatic battery cell, and the coolant communicates out of the pouch via the outlet.

2. The cooling panel from claim 1, wherein the pouch matches the shape of the first blanked sheet and the second blanked sheet and the first blanked sheet and the second blanked sheet together forms the frame to secure the pouch in place.

3. The frame from claim 1 , wherein the frame is composed of either a thinned aluminum or a plastic with a thickness between 0.3 millimeters and 1 millimeter.

4. The cooling panel from claim 1, wherein the coolant is directed into the pouch through the inlet and out of the pouch through the outlet.

5. The cooling panel from claim 1, wherein the cooling panel is disposed within a battery pack housing the prismatic battery cell within a vehicle.

6. The cooling panel from claim 5, wherein the first outer laminate and the second outer laminate are composed of a flexible stainless steel foil.

7. The cooling panel from claim 5, wherein an outer layer of the first outer laminate and the second outer laminate is composed of a thermoplastic polymer with a melting point between 250 and 350 degrees Celsius.

8. The cooling panel from claim 5, wherein an inner layer of the first outer laminate and the second outer laminate is composed of a thermoplastic polymer with a melting point between 160 and 200 degrees Celsius.

9. The cooling panel from claim 5, wherein the pressure from the coolant directed into the pouch through the inlet causes the pouch to expand and communicate with a side surface of the prismatic battery cell.

10. The cooling panel from claim 1, wherein the cooling panel further comprises a first inner laminate and a second inner laminate.

11. The cooling panel from claim 10, wherein the first inner laminate and the second inner laminate are composed of a flexible aluminum foil.

12. The cooling panel from claim 11, wherein a first inner pouch within the pouch would be defined by the space between the first outer laminate and the first inner laminate, a central pouch within the pouch would be defined by the space between the first inner laminate and the second inner laminate, and a second inner pouch within the pouch would be defined by the space between the second inner laminate and the second outer laminate.

13. The cooling panel from claim 11, wherein an outer layer of the first outer laminate and the second outer laminate is composed of a thermoplastic polymer with a melting point between 250 and 350 degrees Celsius and an inner layer of the first outer laminate and the second outer laminate is composed of a thermoplastic polymer with a melting point between 160 and 200 degrees Celsius.

14. The cooling panel from claim 11, wherein a first layer and a third layer of the first inner laminate and the second inner laminate are composed of a thermoplastic polymer with a melting point between 160 and 200 degrees Celsius.

15. The cooling panel from claim 12, wherein the pressure from the coolant directed into the first inner pouch and the second inner pouch through the inlet causes the pouch to expand and communicate with a side surface of the prismatic battery cell.

16. The cooling panel from claim 12, wherein the central pouch is filled with a thermal barrier.

17. The cooling panel from claim 1, wherein a single serpentine channel is heat-sealed within the pouch, allowing for the inlet and the outlet to be disposed within a same edge of the pouch.

18. The cooling panel from claim 1, wherein there are a plurality of round seals heat sealed into the pouch to induce turbulence in the flow of the coolant.

19. A cooling panel for a prismatic battery cell, the cooling panel comprising:
a frame including a first blanked sheet and a second blanked sheet, wherein the first blanked sheet is connected to the second blanked sheet;
a first outer laminate connected to the first blanked sheet;
a second outer laminate connected to the second blanked sheet;
a first inner laminate adjacent to the first outer laminate;
a second inner laminate adjacent to the second outer laminate;
wherein the first outer laminate, the first inner laminate, the second inner laminate, and the second outer laminate are heat-sealed together to create a pouch disposed between the first blanked sheet and the second blanked sheet;
an inlet in communication with the pouch; and
an outlet in communication with the pouch wherein a coolant communicates from the inlet to the pouch to expand the pouch such that the first laminate contacts the prismatic battery cell, and the coolant communicates out of the pouch via the outlet.

20. A cooling panel for a prismatic battery cell, the cooling panel comprising:
a frame including a first blanked sheet and a second blanked sheet; wherein the first blanked sheet is connected to the second blanked
sheet;
wherein the frame has an I-framed shape that can be that situates the frame into a slot in a battery tray;
a first laminate connected to the first blanked sheet;
a second laminate connected to the second blanked sheet;
wherein the first laminate and the second laminate are heat-sealed together to create a pouch disposed between the first blanked sheet and the second blanked sheet;
an inlet in communication with the pouch;
an outlet in communication with the pouch wherein a coolant communicates from the inlet to the pouch to expand the pouch such that the first laminate contacts the prismatic battery cell, and the coolant communicates out of the pouch via the outlet; and
wherein there are a plurality of round seals heat sealed into the pouch to induce turbulence in the flow of the coolant.
